(19) United States
(12) Patent Application Publication
(10) Pub. No.: US 2009/0055597 A1
(43) Pub. Date: Feb. 26, 2009

(54) Method and Device for Sharing Information Between Memory Parcels In Limited Resource Environments

(76) Inventor: Javier Canis Robles, Madrid (ES)

Correspondence Address: BRINKS HOFER GILSON & LIONE/SanDisk, P.O. BOX 10395, CHICAGO, IL, 60610, US

(21) Appl. No.: 11/629,084

(22) PCT Filed: Jun. 9, 2004
(86) PCT No.: PCT/ES2004/000263

§ 371 Date: Oct. 10, 2008

(51) Int. Cl. G06F 12/00

(52) U.S. Cl. 711/147; 711/E12.001

(57) ABSTRACT

The invention relates to the management of information such as data and/or procedures residing in the memory in systems with reduced processing and storing capacity, for example, those available in a smart card. A method and a device disclosed in the invention make it possible for various applications lodged in different memory parcels to safely share data and/or procedures by making optimum use of the processing capacity of the system to which the memory belongs. A strict sharing mechanism ensures that if an application has obtained a data item or a procedure from another application or the system itself in which it is lodged, it has done so because it is authorized to use it and therefore no verification has to be made. The sharing mechanism is based on the principle that data and procedures of one application can only be referenced by another application during its execution and through the sharing mechanisms defined in this invention.

### RELATED APPLICATIONS

This Patent Application is the National Stage of the International Patent Application PCT/ES2004/000263 filed Jun. 9, 2004 by the present inventor.

### PURPOSE OF THE INVENTION

This invention relates to the management of information such as data and/or procedures resident in memory in environments with limited resources, that is, in systems with reduced processing and storage capacity such as, for example, those in a smart card.

More specifically, the invention refers to a method that allows various applications in different parcels of memory to share the data and/or procedures of which they consist, safely and making optimum use of the processing capacity of the system to which the memory belongs.

The invention defines a strict sharing mechanism which ensures that if an application has obtained a datum or procedure from another application or from the system in which the mechanism resides, this is because it is authorised to use it and therefore no checking is necessary. The sharing mechanism is based on the fact that data and procedures from an application may only be referenced by another while it is running and through the sharing mechanisms defined in this invention.

It is also an object of this invention a device consisting of a processor unit that allows the exchange of data and/or procedures between applications residing in two different parcels of memory in the processing unit, safely and making optimum use of the processing capacity of the unit to which the memory belongs.

Another purpose of the invention refers to a smart card which contains the processing unit described above.

### BACKGROUND TO THE INVENTION

The basis of known systems for sharing data and procedures resident in memory, is that the data and procedures belong to specific applications. The system knows which application is running, and continuously controls that the data and procedures in use actually belong to it or that they are data or procedures obtained from a sharing system.

In the known systems there are various applications that can share data between each other, for which each application has a method that is used by the system to obtain the data and procedures to be shared. When the application wishes to obtain data and procedures from another application, it must request them from the system through a method that is offered by the system itself, clearly identifying the application that wishes to obtain them. The system then requests the data and procedures that the application requires from the application, calling the method in the application, and they are delivered.

In these known prior-art systems, the data and procedures permanently belong to an application and may not be used by any other since, while running, the system continuously checks that the data in use belong to the application that is running.

Because of the above mentioned continuous checking, these known techniques for managing the exchange of information between the various parcels of memory require a greater processing time and are therefore slow in handling the information.

### DESCRIPTION OF THE INVENTION

This invention solves the above mentioned problems and provides additional advantages according to the method and devices defined in the independent claims.

The invention provides a sharing method in which the information consisting of data and/or procedures to be shared, does not belong exclusively to a single application but is a much more versatile method with which the data and/or procedures may be used by any application that requires them but following the sharing mechanisms defined in the invention. The method is also safer than known techniques and makes more effective use of the processing capacity of the system in which it is implemented.

This invention defines a method and a device that allow various applications in the system, for example, the processor unit of smart card, to exchange data and/or procedures between each other in an agreed and safe manner. It also allows applications for various external entities, to reside in the same system without compromising the security of the data that they contain.

In this invention, external entities must be understood as systems outside the environment in which the method and device of the invention are implemented, and that act as representatives in the environment of the invention through an application to which they belong, such as a bank, the provider of any type of service, etc.

The system defined in this invention does not need to carry out an exhaustive and continuous control over which application the procedures in use belong to, thus providing greater processing speed, since it saves processing tasks, and gives flexibility to the system. The system defines a strict sharing mechanism that ensures that if an application has obtained a datum from another application or from the system, this is because it may use it and no checking is necessary.

The basis of the sharing mechanism, is that an application may only reference data and procedures of another application that is running and through the sharing mechanisms defined in this invention.

This invention defines a mechanism so that applications in different parcels of memory may share data safely, which is achieved by preventing applications from sharing their data directly; instead, this is carried out through entities that are specialised in and dedicated to the sharing. These entities, called in this invention Sharing Modules, are applications loaded into the system that act as representatives of an entity outside the system and that control the exchange of information between the applications under their control. The exchange of information between the applications, is carried out in the form of Shared Services in the Sharing Modules.

Thus, one aspect of the invention refers to a method of sharing information between parcels of memory in environments with limited resources, designed to provide greater processing speed, security and flexibility in the information sharing and in which the memory parcels may hold one or more applications formed by data and/or procedures. The method is characterized in that it comprises the sharing of data and/or procedures between applications in various parcels of the memory through Sharing Modules consisting of specific applications designed to control the sharing, and that include at least one Sharing Service through which the information sharing is carried out.

A data processing unit participates in the invention, which contains a Sharing Unit and memory for applications, divided into independent Memory Parcels. The Memory Parcels contain data and procedures that make up the applications and that have variable sizes.

The Sharing Unit is a part of the system that is common to all the applications and that contains the Sharing Procedures, which is an interface used by the applications to access the Shared Services offered by the Sharing Units in the system. The Sharing Unit also contains the Sharing Control, which checks that the data and procedures used by a specific application, are not breaking the usage rules defined for the Shared Service.

The usage rules for a Shared Service may set limitations on the use of the service, such as, for example, setting a time limit on its use, limiting its storage or the need to include a key.

Thus, the Sharing Modules are special applications that offer Shared Services to other applications directly or through the sharing unit. The Shared Services are included in the Sharing Modules by the associated applications. According to this invention, each application loaded in the card will preferably have its associated Sharing Module. It is also possible for applications to have no associated Sharing Module, so there is a default Sharing Module to which these applications are assigned. This Module may obtain the Shared Services for the application actively, that is, on its own initiative.

The association between an application and the Sharing Module, is carried out before the application can start to share data with other applications. This association may be carried out, for example, during the loading and/or activating of the application or later during the rest of the phases of the application's life cycle. The association may include mutual authentication between the application and the Sharing Module to guarantee a secure association. From this moment, the application may be registered, that is, Shared Services may be introduced into its associated Sharing Module through the Sharing Procedures belonging to the Sharing Module.

The Sharing Procedures of a Sharing Module allow the associated applications:
1. To register a Sharing Service.
2. To modify a Sharing Service.
3. To delete a Sharing Service.

A Sharing Service consists of: an identifier, references to the data and procedures of the application which registers the service, access conditions and usage rules. Therefore, in order for an application to obtain a Shared Service, it must have the access conditions that allow this. Further, these services may only be used according to the usage rules, if they exist.

In this invention, the basis of the Sharing Mechanism between applications is that data and procedures may only be shared between the different Memory Parcels through the Sharing Modules.

The applications within the same Memory Parcels may share data and procedures as they wish. This is because it is assumed that within a specific Memory Parcel, the applications are of mutual confidence. Therefore, within an application there are data or procedures that are only accessible by the applications sharing the same Memory Parcel. This does not prevent delicate data or procedures existing in an application that are only accessible by that application, without being accessible by other applications in the same Memory Parcel.

The Sharing Procedures in a Sharing Module provide an interface so that applications (regardless of whether they are associated to the Sharing Module) may consult and access the Shared Services. This interface may, for example, allow:
1. Requests to access conditions and the usage rules for a specific Shared Service.
2. Requests for the necessary access conditions for a specific service; the access conditions, for example, may be included in an access key.
3. The obtaining of a Sharing Service, checking that the access conditions have been met.

The Sharing Procedures Module in the Sharing Unit provides an interface so that applications may access the Sharing Modules. This interface may, for example, allow:
1. The obtaining of the reference to a Sharing Module for access to the Sharing Services it contains.
2. Selective searches for Shared Services among all the Sharing Modules, given a search pattern.
3. Selective searches for Sharing Modules, given a search pattern.
4. The obtaining of a Sharing Service, checking that the access conditions have been met.

The Sharing Unit can optionally provide a Sharing Unit that allows it to offer system Shared Services.

Each Shared Service may set usage rules which are controlled by the Sharing Control of the Sharing Unit and that may be, for example:
1. That authentication is necessary in order to access or use the application's data and procedures.
2. That it is temporary, for example, it may not be permanently stored by applications for later use.
3. That the Sharing Service procedures obtained may not be run using application data obtained by these procedures as input parameters.
4. That the Sharing Service data obtained cannot be used directly by the procedures of the application that has obtained the data but may only be used by the procedures of the Sharing Service obtained.
5. That a key is necessary to use the Shared Service obtained.

Another aspect of the invention refers to an information processing unit, that comprises a microprocessor and at least one data memory associated with said microprocessor, in which the data memory is at least temporarily divided into independent memory parcels and in which these memory parcels hold one or more applications consisting of data and/or procedures. The processing unit is designed to speed up processing speed and to improve security and flexibility in sharing these data and/or procedures. The processing unit includes sharing means to exchange data and/or procedures between applications in different memory parcels, and therefore the sharing of these data and/or procedures is carried out through these sharing means.

The processing unit and the memory parcels form part of computerised means which, for example, may be included in the integrated circuit of a smart card.

Thus another aspect of the invention refers to a device consisting of a smart card whose integrated circuit contains the processing unit described above. This processing unit on the card operates according to the method defined in this invention.

### DESCRIPTION OF THE DRAWINGS

To complete this description and to aid the better understanding of the invention's characteristics, according to a preferred example for its implementation method, this description is accompanied by a set of drawings forming an integral part of the description where, for purposes of illustration and in a non-limiting sense the following is shown:

FIG. 1 is a schematic showing various aspects of the invention, with various memory parcels containing applications, sharing modules in various memory parcels and the sharing unit.

FIG. 2 is a schematic showing various applications using the shared services of the sharing modules with which they are associated.

FIG. 3 is a schematic showing various applications obtaining shared services through the sharing procedures of the sharing unit.

FIG. 4 is a diagram showing an example of the operation of the invention involving the sharing unit and the sharing module associated with an application.

FIG. 5 is a diagram showing another example of the operation of the invention involving the sharing unit and a sharing module associated by default with an application which has no previously associated sharing module.

### PREFERRED IMPLEMENTATION METHOD FOR THE INVENTION

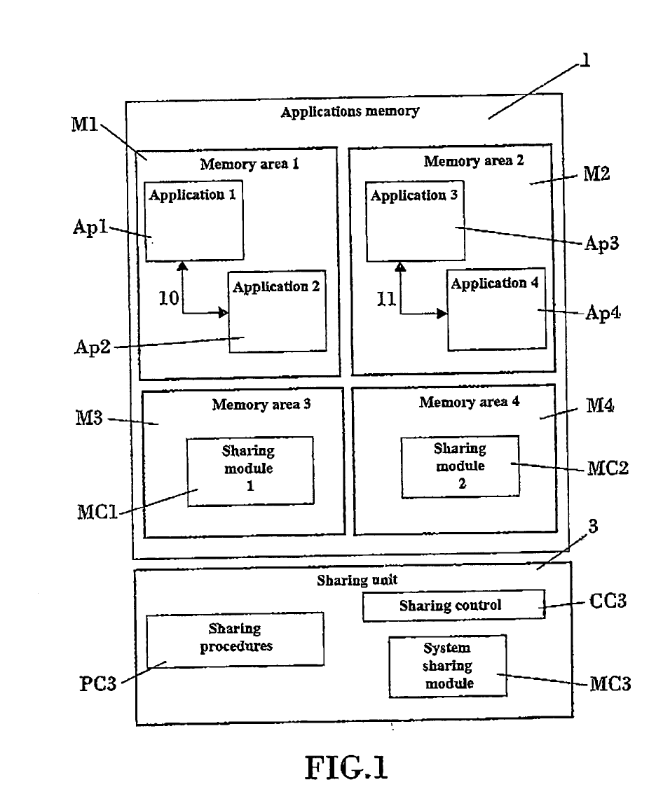

FIG. 1 shows an example of a possible system state in which there are various applications that wish to share or use Shared Services. The applications memory (1) is divided into four Memory Parcels (M1-M4). The Memory Parcel (M1) contains the applications (Ap1) and (Ap2) and Memory Parcel (M2) contains the applications (Ap3) and (Ap4), which can only share data with the applications that are in the same parcel, that is, applications (Ap1) and (Ap2) may share data between each other directly as shown by the arrow (10) and in the same way applications (Ap3) and (Ap4) may share data and/or procedures directly as shown by the arrow (11) since they are within the same memory parcel (M2).

The other two memory parcels (M3) and (M4) each contain a Sharing Module, (MC1) and (MC2), respectively. The applications in each memory parcel may be associated with one of the Sharing Modules (MC1) or MC2), and therefore to share data with an application in another Memory Parcel they must register a Shared Service in their associated Sharing Module. The application that wishes to use a Shared Service, must request it from the Sharing Module that owns the service.

FIG. 1 also shows that the invention includes a Sharing Unit (3), which has a system Sharing Module (MC3) that may be used by the applications to access the system's Shared Services.

Thus it is also possible for applications to request Shared Services through the Sharing Procedures (PC3) of the Sharing Unit (3).

Finally, in the Sharing Unit (3) there is also the Sharing Control (CC3) which guarantees that the usage rules specified for each Shared Service, are complied with by the applications.

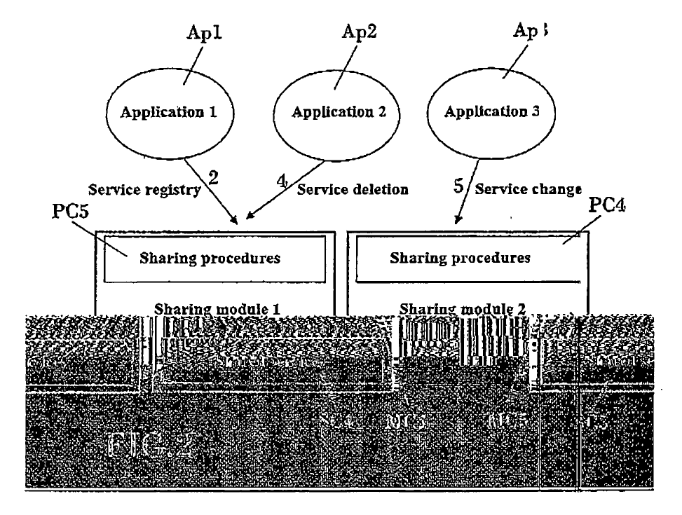

FIG. 2 shows an example of the operation of the method of the invention, in which the applications (Ap1) and (Ap2) are associated with the Sharing Module (MC5) and the application (Ap3) is associated with the Sharing Module (MC4). The Figure also shows how the Sharing Module (MC5) has its own Sharing Procedures (PC5), and the Sharing Services (SC5) that it may offer to the applications which request them. Similarly, the Sharing Module (MC4) has its own Sharing Procedures (PC4) and its Sharing Services (SC4) which it can offer.

The applications may register, delete or change Shared Services in their associated Sharing Modules through the Sharing Procedures. Thus in FIG. 2, the application (Ap1) is registering a service in its associated Sharing Module (MC5), as shown by the arrow (2), through the Sharing Procedure (PC5), and the application (Ap2) is deleting a service, as shown by the arrow (4), in the same Sharing Module (MC5) to which it is also associated. On the other hand, the application (Ap3) is changing a Sharing Service, as shown by the arrow (5), in the associated Sharing Module (MC4) through the Sharing Procedure (PC4).

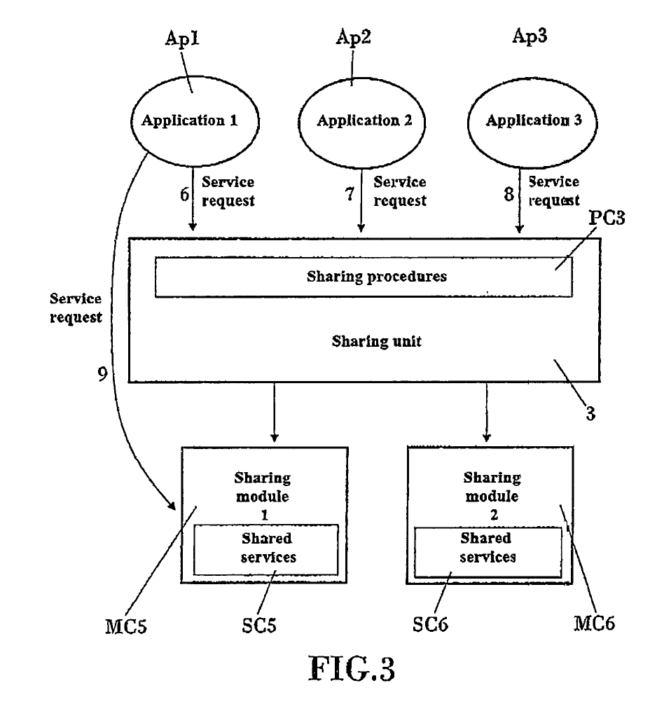

FIG. 3 shows how the applications may also obtain a Shared Service through the Sharing Procedures (PC3) of the Sharing Unit (3), which in turn obtains them from the relevant Sharing Modules (MC5) and (MC6), that is, those Sharing Modules that have and that may offer the Sharing Services requested by the applications (Ap1-Ap3). Simultaneously, it shows, by the arrow (9), the possibility of an application obtaining a Shared Service directly through a Sharing Module to which it has a reference, that is, one that it knows offers a specific service; in the case of FIG. 3, the application (Ap1) is requesting a service directly from the Sharing Module (MC5) which it knows offers a specific service among its Shared Services (SC5).

The application (Ap2) is requesting a service as shown by the arrow (7) through the Sharing Procedures (PC3) of the Sharing Unit (3), and similarly the application (Ap3) is requesting a service as shown by the arrow (8) through this Sharing Unit (3).

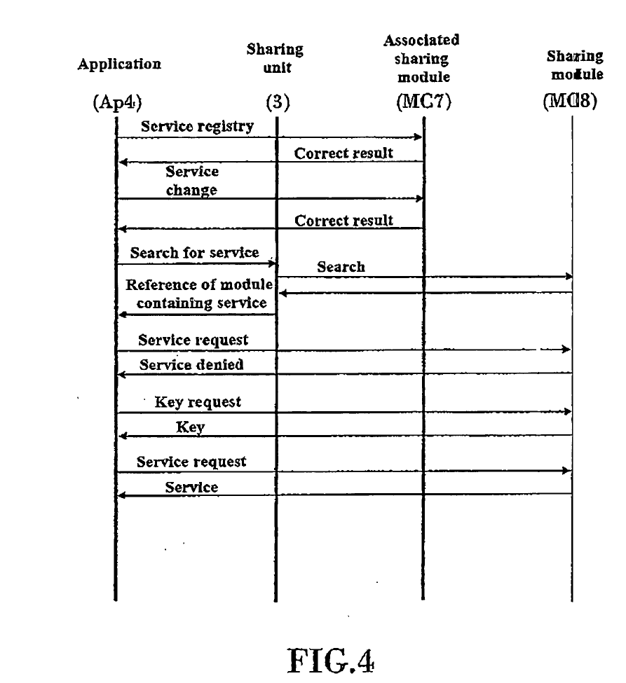

FIG. 4 shows an example of the procedures that an application may use to register and obtain a Shared Service through the Sharing Unit (3).

The diagram shows the application (Ap4), the Sharing Unit (3), the Sharing Module (MC7) associated with the application (Ap4) and another Sharing Module (MC8).

The first step carried out by the application (Ap4) is to register, that is, enter, a Shared Service in the associated Sharing Module (MC7), giving the identifier, references to data and procedures, access conditions and usage rules. The application (Ap4) then, for example, may need to change a parameter of the Shared Service, which it does through the Sharing Module (MC7) that contains it.

The application (Ap4) then searches for a specific Shared Service using the Sharing Unit (3) and obtains the reference to a Sharing Module (MC8) which contains the Shared Service requested, for example, because another application has entered them beforehand. It then requests the service from the Sharing Module (MC8), which is denied since the access conditions are not met because a key is required to access the requested Shared Service. It then requests the key from the Sharing Module (MC8), and, after carrying out the relevant procedures (for example, checking that the application trying to obtain the service is reliable; this checking may be internal to the Sharing Module or may require the exchange of data with a unit outside the Sharing Module (MC8) it delivers the necessary key for obtaining the Shared Service which is then obtained.

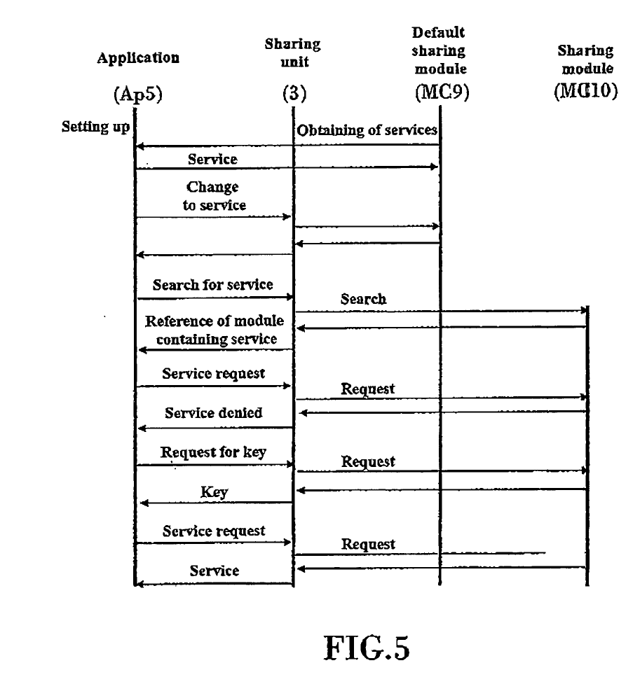

The diagram in FIG. 5 shows an example of the procedures carried out in the system when an application (Ap5) with no associated Sharing Module has Shared Services for sharing.

The diagram shows the application (Ap5), the Sharing Unit (3), the Sharing Module (MC9) associated by default with the application (Ap5) and another Sharing Module (MC10).

Once the application (Ap5) is installed, the system's default Sharing Module (MC9) takes the initiative, requesting from the application the Shared Services that it has. The application (Ap5) then changes its Shared Services through the Sharing Unit (3).

The application (Ap5) then searches for a specific Shared Service using the Sharing Unit (3) and obtains the reference to a Sharing Module (MC10) which contains the requested Shared Service. It then requests the service from the Sharing Module (MC10) through the Sharing Unit (3), which is denied since the access conditions are not met because a key is necessary to access the requested Shared Service. It then requests the key from the Sharing Module (MC10) through the Sharing Unit (3), which, after carrying out the relevant procedures (these may be internal or external to the Sharing Module) gives it the necessary key to obtain the Shared Service, which is then obtained through the Sharing Unit (3).

The following is an example of a practical use of this invention.

The system is to be used by the user for various purchases, for example, to pay in a shop, download multimedia contents in the system after paying for them, purchase cinema tickets, etc.

For this, a bank loads a financial application in the system. The financial application may set up a link with the bank that owns the application to increase or decrease the available balance or to query the balance. This application will offer payment services to third applications, which will consist of certificates that validate the payments made by third applications.

The financial application belongs to the bank, so in order to offer services to third applications according to the invention, it must associate itself with a Sharing Module that is of total confidence to the bank. The secure Sharing Module may be used in the future by the bank so that other applications belonging to the bank may also offer their services to third applications.

This association is carried out by the financial application with prior verification by the Sharing Module and by the financial application that the application and the Sharing Module, respectively, are secure.

The financial application may then register the payment service in the Sharing Module. This Sharing Service is characterized by:
1. An identifier which identifies it or a reference as financial service payment.
2. Procedures that allow a payment to be certified.
3. Access conditions that are met before the presentation of the certificate that identifies it to the application that wishes to obtain the service.
4. Usage rules that set a time limit for the service.

A purchasing application is then loaded into the system which communicates with the point of sale through, for example, a infra-red port provided in the system.

When the user wishes to pay through the infra-red purchasing application, this application requests information on financial services from the Sharing Unit (3) through the Sharing Procedures (PC3), obtaining a reference to the Sharing Module that has the service. The application requests the service from the Sharing Module, which in turn requests the certificate from the requesting application and locally or remotely checks that the application is authorised to obtain this service. Once the service has been obtained, and through its procedures, the payment is made and the payment service internally requests a PIN from the user to check that the user agrees with the payment.

Once the payment has been made, the service obtained by the application expires according to the usage rules set; to re-use the service, it must be obtained again.

The user then wishes to download multimedia contents in the system, for which a download application is loaded, for example by GPRS for paid multimedia contents. For this, the application requests from the Sharing Unit (3) through the Sharing Procedures (PC3) information on financial services and GPRS services, obtaining a reference to the Sharing Modules that have these services, which have previously been registered by other applications. The application requests the services from the Sharing Modules. Once the services have been obtained, and through their procedures, the multimedia contents are downloaded through the paid GPRS service using the financial service.

Specific embodiments of the invention are described in the attached dependent claims.

On seeing this description and set of drawings, a skilled person in the art will be able to understand that the implementations of the invention described may be combined in many ways within the purpose of the invention. The invention has been described according to some preferred embodiments of it, but for a skilled person in the art, it will be clear that many variations may be made to the preferred embodiments without departing from the object of the claimed invention.

1-33. (canceled)

34) A smartcard memory management system for sharing of procedures in a smartcard device, the smartcard device having a memory partitioned into a plurality of independent memory parcels including a first memory parcel configured to store a first application including at least one procedure, and a second memory parcel different from the first memory parcel configured to store a second application different from the first application, the memory management system comprising:
a) at least one sharing module, said at least one sharing module comprising a first sharing module that is operative, after association with the first application, to provide to the second application stored in the second memory parcel, sharing of at least one procedure of the first application stored in the first memory parcel that is independent from the second memory parcel.

35) The memory management system of claim 34 wherein said sharing module is operative to provide said sharing only if at least one access condition has been met by the second application.

36) The memory management system of claim 34 wherein said sharing module is operative such that said providing sharing is contingent on at least one usage rule.

37) The memory management of claim 34 wherein said sharing module is operative such that said association includes mutual authentication.

38) The memory management system of claim 34 wherein said at least one sharing module comprises a plurality of said sharing modules, each said sharing module being operative to handle sharing for a distinct corresponding at least one application handled by said each sharing module.

39) The memory management system of claim 38 further comprising:
b) a search interface for providing search access in accordance with a search pattern to a given said sharing module selected from said plurality of sharing modules.

40) The memory management system of claim 38 further comprising:
b) a search interface for providing search access in accordance with a search pattern to a given service associated with module-provided sharing of a given said shared procedure.

41) The memory management system of claim 34 wherein said sharing module is operative to provide a reversible said sharing of said at least one procedure of the first application that is reversible in accordance with at least one of:
i) a time limitation; and
ii) a request to delete a service.

42) The memory management system of claim 34 wherein said sharing module is operative to provide a storage-limited said sharing of said at least one procedure of the first application.

43) The memory management system of claim 34 wherein said providing of said sharing is contingent on a checking that the second application is authorized to access said at least one procedure of the first application.

44) The memory management system of claim 34 wherein said association is selected from the group consisting of a launch-time registeration and an installation time registration.

45) The memory management system of claim 34 wherein said sharing is a keyed sharing contingent on a providing, by the second application, of a valid key.

46) In a smartcard device having a memory partitioned into a plurality of independent memory parcels including a first memory parcel configured to store a first application including at least one procedure and a second memory parcel different from the first memory parcel configured to store a second application different from the first application, a method of memory management comprising:
a) associating a sharing module with the first application that is stored in the first memory parcel;
b) providing, to the second application stored in the second memory parcel independent of the first memory parcel, using said associated sharing module, a sharing of at least one procedure of the first application stored in the first memory parcel.

47) The method of claim 46 wherein said providing of said sharing by said associated sharing module is contingent on at least one access condition being met by the second application.

48) The method of claim 46 said providing of said sharing by said associated sharing module is contingent on at least one usage rule.

49) The memory management of claim 34 wherein said associating includes mutual authentication.

50) The method of claim 46 said providing of said sharing by said associated sharing module is reversible after expiration of a pre-determined time period.

51) The method of claim 46 further comprising:
c) upon handling a directive to delete a service associated with the shared at least one procedure, ceasing to provide said sharing.

52) The method of claim 46 wherein said provided sharing is storage-limited said sharing of said at least one procedure of the first application.

53) The method of claim 46 wherein said providing of said sharing is contingent on a checking that the second application is authorized to access said at least one procedure of the first application.

54) The method of claim 46 wherein said associating is selected from the group consisting of a launch-time registration and an installation time registration.

55) The method of claim 46 wherein said provided sharing is a keyed sharing contingent on a providing, by the second application, of a valid key.

56) A computer readable storage medium having computer readable code embodied in said computer readable storage medium, said computer readable code comprising instructions for a smartcard device having a memory partitioned into a plurality of independent memory parcels including a first memory parcel configured to store a first application including at least one procedure and a second memory parcel different from the first memory parcel configured to store a second application different from the first application to:
a) associate a sharing module with the first application that is stored in the first memory parcel;
b) provide, to the second application stored in the second memory parcel independent of the first memory parcel, using said associated sharing module, a sharing of at least one procedure of the first application stored in the first memory parcel.

57) A smartcard device comprising:
a) a memory for storing smartcard applications, said memory partitioned into a plurality of independent memory parcels;
b) a plurality of said smartcard applications including a first said smartcard application residing on a first said memory parcel and a second said application residing on a second said memory parcel different from said first memory parcel, said first application comprising at least one procedure; and
c) a memory management system including a sharing module that is operative, after association with the first application, to permit to said second application stored in the second memory parcel, sharing of at least one said procedure of the first application stored in the first memory parcel that is independent from the second memory parcel.
